(19) United States
(12) Patent Application Publication
(10) Pub. No.: US 2013/0097207 A1
(43) Pub. Date: Apr. 18, 2013

(54) INFORMATION PROCESSING DEVICE, INFORMATION PROCESSING METHOD AND COMPUTER PROGRAM

(71) Applicant: Akira SASSA, Saitama (JP)

(72) Inventor: Akira SASSA, Saitama (JP)

(73) Assignee: SONY CORPORATION, Tokyo (JP)

(21) Appl. No.: 13/604,848

(22) Filed: Sep. 6, 2012

(30) Foreign Application Priority Data
Oct. 12, 2011 (JP) 2011-224640

(51) Int. Cl. G06F 17/30

(52) U.S. Cl. 707/803; 707/E17.044

(57) ABSTRACT

There is provided an information processing device including a metadata reception portion that receives metadata that is attached to content data and transmitted, a metadata analysis portion that analyzes the metadata received by the metadata reception portion, and a content data storage portion that determines a storage method of the content data based on a result of the analysis by the metadata analysis portion. Based on the analysis by the metadata analysis portion, the content data storage portion changes a directory structure when storing the content data, in accordance with a content of a predetermined element of the metadata received by the metadata reception portion.

### BACKGROUND

The present disclosure relates to an information processing device, an information processing method and a computer program.

In ID management when providing applications and data, arranging IDs in a hierarchical structure is generally performed in related art (refer to Japanese Patent Application Publication No. JP-A-2007-89014, for example). When the hierarchical structure is used to manage IDs, even if a manufacturer and a vender etc. are allowed to independently manage IDs in a hierarchy equal to or lower than a certain hierarchy, it is possible to uniquely manage all the IDs as a whole, as long as IDs are independent in a hierarchy higher than the certain hierarchy.

### SUMMARY

However, when IDs are arranged in a hierarchical structure and IDs in a higher hierarchy than a certain hierarchy are separately managed, in a hierarchy equal to or lower than the certain hierarchy, grouping across the higher hierarchy cannot be performed and the IDs cannot be associated with each other. Further, even when the IDs in the higher hierarchy are separately managed, when applications and data (hereinafter, the applications and data are also collectively referred to as “content”) are provided to client terminals, unless a directory management method is also taken into consideration, it is necessary for the manufacturer and the vender to use management methods that are different from each other, resulting in complicated management.

In light of the above-described problems, the present disclosure provides an information processing device, an information processing method and a computer program that are new and improved and that are capable of easily managing applications and data by receiving metadata to which are attached IDs that are managed while also taking directory management into consideration.

According to an embodiment of the present disclosure, there is provided an information processing device, including a metadata reception portion that receives metadata that is attached to content data and transmitted, a metadata analysis portion that analyzes the metadata received by the metadata reception portion, and a content data storage portion that determines a storage method of the content data based on a result of the analysis by the metadata analysis portion. Based on the analysis by the metadata analysis portion, the content data storage portion changes a directory structure when storing the content data, in accordance with a content of a predetermined element of the metadata received by the metadata reception portion.

Further, according to an embodiment of the present disclosure, there is provided an information processing method, including receiving metadata that is attached to content data and transmitted, analyzing the metadata received in the metadata receiving step, and determining a storage method of the content data based on a result of the analysis in the metadata analyzing step. Based on the analysis by the metadata analyzing step, the content data storing step changes a directory structure when storing the content data, in accordance with a content of a predetermined element of the metadata received in the metadata receiving step.

Further, according to an embodiment of the present disclosure, there is provided a computer program, including instructions that command a computer to perform receiving metadata that is attached to content data and transmitted, analyzing the metadata received in the metadata receiving step, and determining a storage method of the content data based on a result of the analysis in the metadata analyzing step. Based on the analysis by the metadata analyzing step, the content data storing step changes a directory structure when storing the content data, in accordance with a content of a predetermined element of the metadata received in the metadata receiving step.

According to the present disclosure described above, it is possible to provide an information processing device, an information processing method and a computer program that are new and improved and that are capable of easily managing applications and data by receiving metadata to which are attached IDs that are managed while also taking directory management into consideration.

### BRIEF DESCRIPTION OF THE DRAWINGS

FIG. 1 is an explanatory diagram showing a system configuration example of an information processing system 1 according to an embodiment of the present disclosure;

FIG. 2 is an explanatory diagram showing a configuration example of a digital camera 100 according to the embodiment of the present disclosure;

FIG. 3 is an explanatory diagram showing an example of a structure of metadata that is used in the information processing system 1 according to the embodiment of the present disclosure;

FIG. 4 is an explanatory diagram showing a mode setting example;

FIG. 5 is an explanatory diagram showing relationships between modes and directory structures;

FIG. 6 is a flowchart showing operations of the digital camera 100 according to the embodiment of the present disclosure;

FIG. 7 is an explanatory diagram showing a directory structure of the digital camera 100 according to the embodiment of the present disclosure:

FIG. 8 is an explanatory diagram showing a directory structure of the digital camera 100 according to the embodiment of the present disclosure;

FIG. 9 is an explanatory diagram showing a directory structure of the digital camera 100 according to the embodiment of the present disclosure;

FIG. 10 is an explanatory diagram showing a directory structure of the digital camera 100 according to the embodiment of the present disclosure;

FIG. 11 is an explanatory diagram showing a directory structure of the digital camera 100 according to the embodiment of the present disclosure;

FIG. 12 is an explanatory diagram showing a directory structure of the digital camera 100 according to the embodiment of the present disclosure;

FIG. 13 is an explanatory diagram showing a directory structure of the digital camera 100 according to the embodiment of the present disclosure;

FIG. 14 is an explanatory diagram showing a directory structure of the digital camera 100 according to the embodiment of the present disclosure;

FIG. 15 is an explanatory diagram showing a directory structure of the digital camera 100 according to the embodiment of the present disclosure;

FIG. 16 is an explanatory diagram showing a configuration example of metadata;

FIG. 17 is an explanatory diagram showing an example of content of an application or data;

FIG. 18 is an explanatory diagram showing an example of a structure of the metadata that is used in the information processing system 1 according to the embodiment of the present disclosure;

FIG. 19 is an explanatory diagram showing a functional configuration example of an application download server 10 according to the embodiment of the present disclosure;

FIG. 20 is an explanatory diagram showing an example of content of a device matching database 12;

FIG. 21 is an explanatory diagram showing a hierarchical structure that is used when providing an application and data to client devices;

FIG. 22 is a flowchart showing a flow of processing between a content registrant and a download server, in the information processing system 1 according to the embodiment of the present disclosure;

FIG. 23 is a flowchart showing a flow of processing between a client device and the download server;

FIG. 24 is a flowchart showing a flow of content registration by the content registrant;

FIG. 25 is a flowchart showing a flow of content search and acquisition processing by the client device;

FIG. 26 is a flowchart showing content search and transmission processing by the download server; and

FIG. 27 is an explanatory diagram showing a system configuration example of the information processing system 1 according to the embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the explanation will be made in the following order.

1. Embodiment of Present Disclosure

System Configuration Example

Configuration Example of Digital Camera

Operations of Digital Camera

2. Conclusion

### 1. Embodiment of Present Disclosure

### System Configuration Example

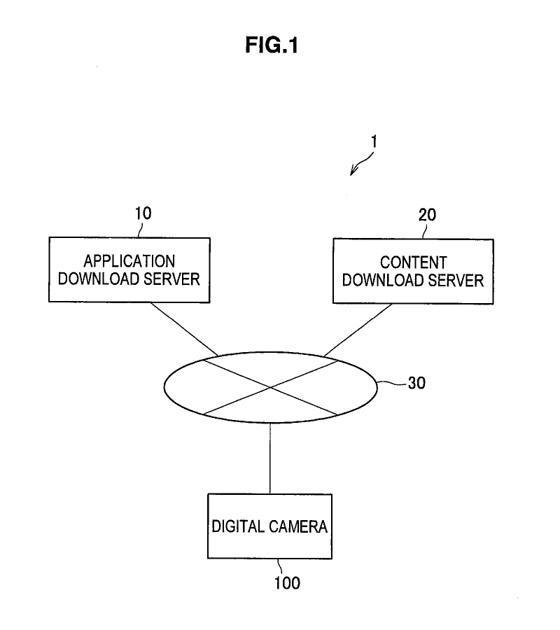

First, a system configuration example according to an embodiment of the present disclosure will be explained. FIG. 1 is an explanatory diagram showing a system configuration example of an information processing system 1 according to the embodiment of the present disclosure. Hereinafter, the system configuration example of the information processing system 1 according to the embodiment of the present disclosure will be explained with reference to FIG. 1.

As shown in FIG. 1, the information processing system 1 according to the embodiment of the present disclosure is provided with an application download server 10, a content download server 20 and a digital camera 100. The application download server 10, the content download server 20 and the digital camera 100 are mutually connected via an Internet 30. Note that, although in FIG. 1 the respective devices are shown as single devices, it is needless to mention that the present disclosure is not limited to this example.

The application download server 10 holds an application to be executed by the digital camera 100, and provides the application via the Internet 30 in response to a request from the digital camera 100. The content download server 20 holds content (for example, data etc. used by the application that is provided by the application download server 10) to be executed by the digital camera 100, and provides the content via the Internet 30 in response to a request from the digital camera 100.

The digital camera 100 is a camera that is used to capture still images or moving images. In the present embodiment, the digital camera 100 has a function to connect to the Internet 30, and the digital camera 100 can access the application download server 10 and the content download server 20. The digital camera 100 can download, via the Internet 30, the application held by the application download server 10 and the content held by the content download server 20.

In the present embodiment, metadata that is described in a predetermined format is attached to the application that is downloaded from the application download server 10 or to the content that is downloaded from the content download server 20. When the application or data is stored, the digital camera 100 can determine a storage destination of the application or data by analyzing the metadata. Analysis processing of the metadata and determination processing of the storage destination of the application or data, which are performed by the digital camera 100, will be described in more detail later.

The digital camera 100 can be wirelessly connected to the Internet 30. However, it may be connected to the Internet 30 via a wired connection. The application download server 10 and the content download server 20 can be connected to the Internet 30 via a wired connection. However, they may be wirelessly connected to the Internet 30.

Hereinabove, the system configuration example of the information processing system 1 according to the embodiment of the present disclosure is explained with reference to FIG. 1. Next, a configuration example of the digital camera 100 according to the embodiment of the present disclosure will be explained.

### Configuration Example of Digital Camera

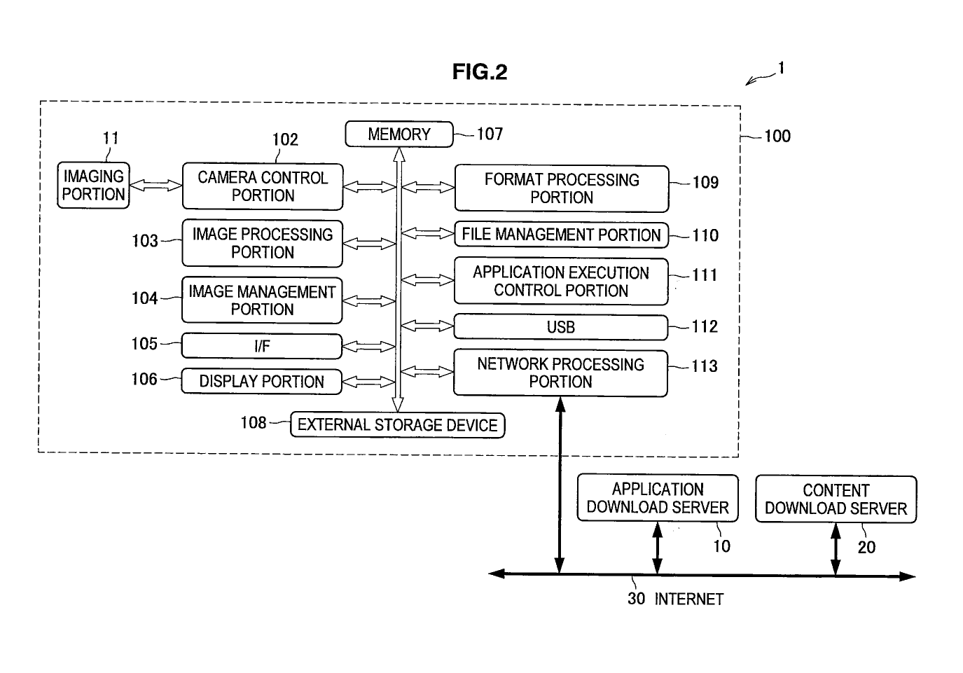

FIG. 2 is an explanatory diagram showing a configuration example of the digital camera 100 according to the embodiment of the present disclosure. Further,

FIG. 2 shows the application download server 10 and the content download server 20 that are connected to the Internet 30. Hereinafter, the configuration example of the digital camera 100 according to the embodiment of the present disclosure will be explained with reference to FIG. 2.

As shown in FIG. 2, the digital camera 100 according to the embodiment of the present disclosure is provided with an imaging portion 101, a camera control portion 102, an image processing portion 103, an image management portion 104, an I/F 105, a display portion 106, a memory 107, an external storage device 108, a format processing portion 109, a file management portion 110, an application execution control portion 111, a USB 112 and a network processing portion 113.

The imaging portion 101 performs imaging processing. The imaging portion 101 is provided with a zoom lens, a focus lens, and an imaging device, such as a charge coupled device (CCD) image sensor or a complementary metal oxide semiconductor (CMOS) image sensor, and converts light from a photographic subject to an electrical signal (an image signal). The camera control portion 102 performs control of the imaging portion 101. Based on operations by a user of the digital camera 100, the camera control portion 102 controls operations of the zoom lens and the focus lens that are included in the imaging portion 101, for example, or controls a timing of light entering the imaging device.

The image processing portion 103 performs signal processing on the image signal obtained by the imaging portion 101, and obtains image data. The image processing portion 103 may perform noise removing processing, compression processing or the like, for example, as the signal processing on the image signal. The image management portion 104 manages display on the display portion 106 of the image data obtained by the image processing portion 103, and storage of the image data in the external storage device 108.

The I/F 105 is an interface to connect a flash or another device to the digital camera 100. The display portion 106 displays images captured by the imaging portion 101, and a user interface and other information used to operate the digital camera 100. The display portion 106 is a flat panel display device, such as a liquid crystal display, an organic EL display or the like.

The memory 107 temporarily stores data when the digital camera 100 performs certain processing. The memory 107 may be, for example, a nonvolatile memory in which the stored data is cleared when a power source of the digital camera 100 is turned off.

The external storage device 108 is a memory card or another external storage device that is used to store the image data generated by the image processing portion 103, the application downloaded from the application download server 10, and the content downloaded from the content download server 20. Storage of the image data into the external storage device 108 and reading of the image data from the external storage device 108 are performed by the image management portion 104, for example.

The format processing portion 109 analyzes the content of the metadata that is attached to the application that is downloaded from the application download server 10 or to the content that is downloaded from the content download server 20. The format processing portion 109 analyzes the content of the metadata and controls file management, by the file management portion 110, of the application downloaded from the application download server 10 or the content data downloaded from the content download server 20. The format processing portion 109 is an example of a metadata analysis portion according to an embodiment of the present disclosure.

The file management portion 110 manages storage, in the external storage device 108, of the application downloaded from the application download server 10 or the content downloaded from the content download server 20. When the application or data is stored in the external storage device 108, the file management portion 110 uses an analysis result of the metadata analyzed by the format processing portion 109. Analysis processing of the metadata that is performed by the format processing portion 109, and storage processing of the application or data into the external storage device 108 that is performed by the file management portion 110 using the analysis result will be described in more detail later. The file management portion 110 is an example of a content storage portion according to an embodiment of the present disclosure.

The application execution control portion 111 executes the application that is downloaded from the application download server 10 and stored in the external storage device 108. When the application stored in the external storage device 108 is executed, the application execution control portion 111 may use the content that is downloaded from the content download server 20 and stored in the external storage device 108.

The USB 112 is an interface to connect the digital camera 100 and another device via a USB cable. The network processing portion 113 performs connection processing to connect to the Internet 30. Through the connection processing to connect to the Internet 30 by the network processing portion 113, the digital camera 100 is able to download the application or data from the application download server 10 or the content download server 20 that are connected to the Internet 30. Then, using the downloaded application or data, the digital camera 100 is able to improve the function of the digital camera 100, to perform detailed customization in accordance with an intended purpose of the user, or to use new content. The network processing portion 113 is an example of a metadata reception portion according to an embodiment of the present disclosure.

Hereinabove, the configuration example of the digital camera 100 according to the embodiment of the present disclosure is explained with reference to FIG. 2. Next, operations of the digital camera 100 according to the embodiment of the present disclosure will be explained.

Operations of Digital Camera

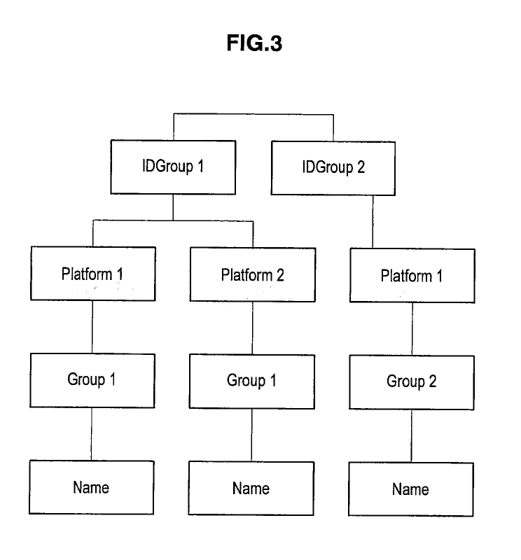

First, before specifically explaining operations of the digital camera 100 according to the embodiment of the present disclosure, an example of a structure of metadata that is used in the information processing system 1 according to the embodiment of the present disclosure will be explained. FIG. 3 is an explanatory diagram showing the example of the structure of the metadata that is used in the information processing system 1 according to the embodiment of the present disclosure.

As shown in FIG. 3, the metadata that is used in the information processing system 1 according to the embodiment of the present disclosure has a hierarchical structure that is formed by four elements, i.e., “IDGroup”, “Platform”, “Group” and

“Name”. “IDGroup” corresponds to the highest hierarchy and the hierarchical level decreases in an order of “Platform”, “Group” and “Name”.

“IDGroup” is a unique ID that is assigned to each of organizations that perform ID management using a format folder, for example. The elements that are equal to or lower than “IDGroup” are managed by each of the organizations in their own way such that “Platform”, “Group” and “Name” are unique.

“Platform” is an ID in which is recorded a platform name that is set in units of operating systems (OS) or product groups, for example. Among the elements that are equal to or lower than “IDGroup”, “Platform” is a unique ID. However, depending on an agreement between the organizations that perform ID management, a same ID can be set for “Platform” across “IDGroup”.

“Group” is an ID that is uniquely assigned among the elements that are equal to or lower than “Platform”. For example, “Group” indicates a group name of data that can be commonly handled in a certain platform, such as data having a same format and different contents, for example. For example, depending on an agreement between the organizations that perform ID management, a same ID can be set for “Group” elements across “IDGroup”.

“Name” is an ID that is uniquely assigned among the elements that are equal to or lower than “Group”. For example, an application name or a data name is set as the ID. “Name” may be used as a home directory name of the application. The elements equal to or lower than “Name” may be managed such that respective applications and data have a given structure.

In the example of the hierarchical structure shown in FIG. 3, “IDGroup1” and “IDGroup2” are set for “IDGroup”. “Platform1” and “Platform2” are set for “IDGroup1”, and “Platform1” is set for “IDGroup2”. Accordingly, the same “Platform”, i.e. “Platform1”, is set for “IDGroup1” and “IDGroup2”.

Then, the same “Group”, i.e. “Group1”, is set for each of “Platform1” and “Platform2” of “IDGroup1”. “Group2” is set for “Group” of “Platform1” of “IDGroup2”.

In order to manage “Platform” and “Group” across “IDGroup”, a mode to manage them across “IDGroup” is set. Next, a mode setting example to manage “Platform” and “Group” across “IDGroup” will be explained.

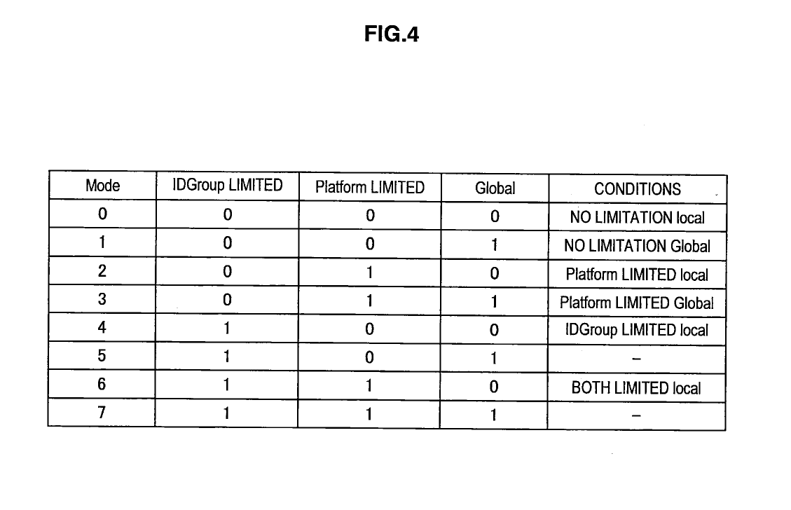

FIG. 4 is an explanatory diagram showing a mode setting example to manage “Platform” and “Group” across “IDGroup”. FIG. 4 shows an example to manage three flags, each of which is 0 or 1, using a single variable “Mode”.

“Global” is a flag to determine whether or not to manage “Platform” and “Group” across “IDGroup” (namely, whether or not to globally manage “Platform” and “Group”), for each application or data. “0” indicates that “Platform” and “Group” are not globally managed (namely, “0” indicates that the application or data locally manages “Platform” and “Group”), and “1” indicates that “Platform” and “Group” are globally managed. When locally managed, the elements that are equal to or lower than “IDGroup” are managed completely independently.

If there is no possibility that a particular device handles another “IDGroup” and another “Platform” when handling the application or data, “IDGroup Limited” and “Platform Limited” are used as flags to simplify the processing in the particular device. Although in the present embodiment, “IDGroup” and “Platform” can be independently specified, it is needless to mention that the present disclosure is not limited to this example.

“IDGroup Limited” and “Platform Limited” are effective when there is a file related constraint in the particular device when handling the application or data. For example, when the device that handles the application or data adopts a file system in which a file name having a length that is equal to or longer than a predetermined length cannot be set, settings of “IDGroup Limited” and “Platform Limited” are effective.

In order to manage the three flags, each of which is 0 or 1 as shown in FIG. 4, using the single variable “Mode”, the variable “Mode” can take values from 0 to 7 as shown in FIG. 4. Setting of the variable “Mode” is included in the metadata that is attached to the application or data. Specifically, the setting is described in “GlobalMode” meta information in a metadata format, which will be described later.

Note that, in the present disclosure, the setting of the variable “Mode” is not limited to this example, and the setting of the variable “Mode” may be held inside each device to which an application or content data is downloaded and may be referred to when the application or the content data is downloaded.

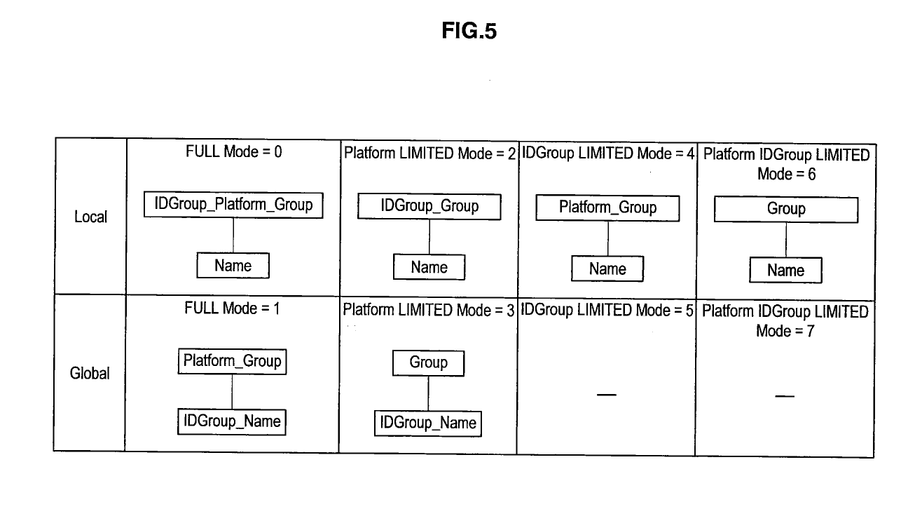

Next, a relationship between modes and directory structures will be explained. FIG. 5 is an explanatory diagram showing relationships between modes and directory structures, in the information processing system 1 according to the embodiment of the present disclosure.

When the application or the content data is stored inside the device, the information processing system 1 according to the embodiment of the present disclosure uses the four elements, i.e., “IDGroup”, “Platform”, “Group” and “Name” shown in FIG. 3, and the setting of the variable “Mode” shown in FIG. 4.

The upper section of the table shown in FIG. 5 shows a directory structure when “Platform” and “Group” are locally managed by each device, and the lower section shows a directory structure when at least one of “Platform” and “Group” is globally managed.

When the variable “Mode” is 0, each device locally manages “Platform” and “Group” and the directory structure is formed such that there is no limitation on “IDGroup” and “Platform”. A directory name “IDGroup_Platform_Group”, which is formed by combining the names of three of the elements by a predetermined separator (here, an under bar (“_”) is used as the separator), is assigned to a parent directory, and a directory name formed of the “Name” element is assigned to a child directory. Note that it is preferable to limit the name of each element such that the same character as the above-described separator is not used in the name of each element.

When the variable “Mode” is 2, each device locally manages “Platform” and “Group”, and the directory structure is formed such that there is no limitation on “IDGroup” and a limitation is imposed on “Platform” only. A directory name “IDGroup_Group”, which is formed by combining the names of two of the elements by the under bar, is assigned to the parent directory, and the directory name formed of the “Name” element is assigned to the child directory.

When the variable “Mode” is 4, each device locally manages “Platform” and “Group”, and the directory structure is formed such that a limitation is imposed on “IDGroup” only and there is no limitation on “Platform”. A directory name “Platform_Group”, which is formed by combining the names of two of the elements by the under bar, is assigned to the parent directory, and the directory name formed of the “Name” element is assigned to the child directory.

When the variable “Mode” is 6, each device locally manages “Platform” and “Group”, and the directory structure is formed such that there is a limitation on both “IDGroup” and “Platform”. A directory name that is formed of the “Group” element only is assigned to the parent directory, and the directory name formed of the “Name” element is assigned to the child directory.

When the variable “Mode” is 1, “Platform” and “Group” are globally managed, and the directory structure is formed such that there is no limitation on “IDGroup” and “Platform”. The directory name “Platform_Group”, which is formed by combining the names of two of the elements by the under bar, is assigned to the parent directory, and a directory name “IDGroup_Name”, which is formed by combining the names of two of the elements by the under bar, is assigned to the child directory.

When the variable “Mode” is 3,“Platform” and “Group” are globally managed, and the directory structure is formed such that there is no limitation on “IDGroup” and a limitation is imposed on “Platform” only. The directory name that is formed of the name of the single element “Group” only is assigned to the parent directory, and the directory name “IDGroup_Name”, which is formed by combining the names of two of the elements by the under bar, is assigned to the child directory.

Note that, if the variable “Mode” is 5, the directory structure is the same as that when the variable “Mode” is 4, and if the variable “Mode” is 7, the directory structure is the same as that when the variable “Mode” is 6. Therefore, the variable “Mode” may be set such that it does not take the values of 5 and 7.

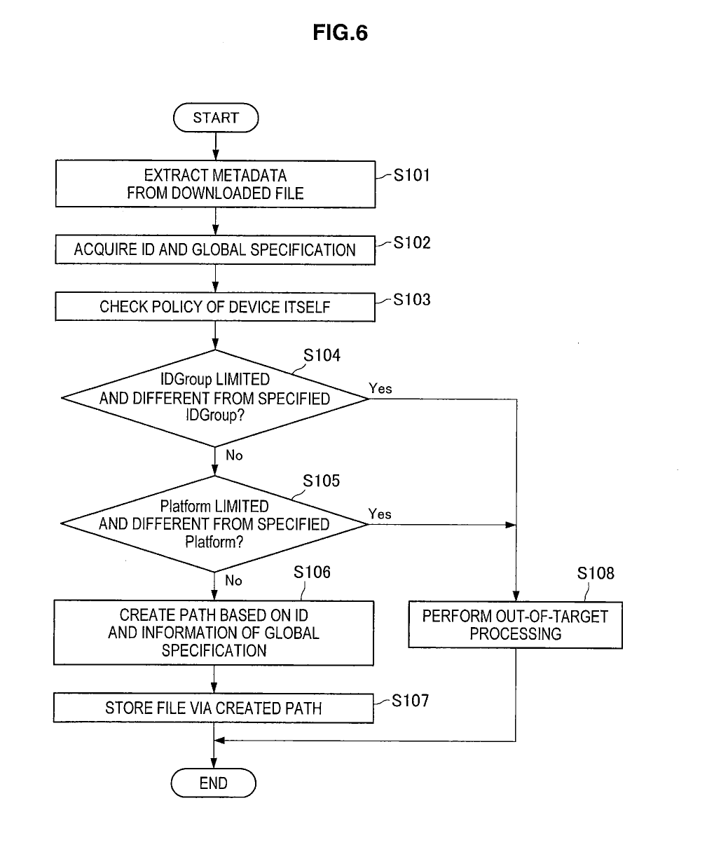

Next, operations of the digital camera 100 according to the embodiment of the present disclosure will be specifically explained. FIG. 6 is a flowchart showing the operations of the digital camera 100 according to the embodiment of the present disclosure. The flowchart shown in FIG. 6 shows the operations of the digital camera 100 that are performed when the digital camera 100 downloads an application or data from the application download server 10 or from the content download server 20. Hereinafter, the operations of the digital camera 100 according to the embodiment of the present disclosure will be specifically explained with reference to FIG. 6.

When the digital camera 100 downloads an application or data from the application download server 10 or from the content download server 20, the format processing portion 109 extracts, from a downloaded file, management metadata for managing the application or data (step S101).

When the format processing portion 109 extracts the management metadata for managing the application or data at step S101 described above, then the format processing portion 109 analyzes the content of the extracted management metadata. Specifically, the format processing portion 109 acquires the content of the “GlobalMode” meta information included in the extracted management metadata and ascertains the content of a mode of the downloaded application or data. Then, the format processing portion 109 ascertains the content of “IDGroup” meta information and “Platform” meta information included in the extracted management metadata (step S102).

After the format processing portion 109 analyzes the content of the extracted management metadata and ascertains the content of the meta information at step S102 described above, the format processing portion 109 checks a policy of the digital camera 100 (step S103). Specifically, when “IDGroup Limited” is set in the “GlobalMode” meta information, the format processing portion 109 checks the

“IDGroup” setting of the digital camera 100. If “Platform Limited” is set in the “GlobalMode” meta information, the format processing portion 109 checks the “Platform” setting of the digital camera 100.

After the format processing portion 109 checks the policy of the digital camera 100 at step S103 described above, then the file management portion 110 determines whether “IDGroup Limited” is set in the “GlobalMode” meta information and whether the content of the “IDGroup” meta information included in the management metadata extracted by the format processing portion 109 is different from the “IDGroup” setting of the digital camera 100 (step S104).

As a result of the determination at step S104 described above, if “IDGroup Limited” is not set in the “GlobalMode” meta information, or if “IDGroup Limited” is set and the content of the “IDGroup” meta information included in the management metadata extracted by the format processing portion 109 is the same as the “IDGroup” setting of the digital camera 100, then the file management portion 110 determines whether “Platform Limited” is set in the “GlobalMode” meta information and whether the content of the “Platform” meta information included in the management metadata extracted by the format processing portion 109 is different from the “Platform” setting of the digital camera 100 (step S105).

As a result of the determination at step S105 described above, if “Platform Limited” is not set in the “GlobalMode” meta information, or if “Platform Limited” is set and the content of the “Platform” meta information included in the management metadata extracted by the format processing portion 109 is the same as the “Platform” setting of the digital camera 100, the file management portion 110 creates a path for storing the application or data, based on the content of the meta information extracted by the format processing portion 109 (step S106). The creation, by the file management portion 110, of the path for storing the application or data will be described in more detail later.

When the file management portion 110 creates the path for storing the application or data at step S106 described above, the file management portion 110 stores the downloaded application or data via the path created at step S106 described above, under a route directory (step S107). The downloaded application or data is stored in the external storage device 108, for example.

On the other hand, at step S104 described above, if “IDGroup Limited” is set in the “GlobalMode” meta information and the content of the “IDGroup” meta information included in the management metadata extracted by the format processing portion 109 is other than the “IDGroup” setting of the digital camera 100, or at step S105 described above, if “Platform Limited” is set in the “GlobalMode” meta information and the content of the “Platform” meta information included in the management metadata extracted by the format processing portion 109 is other than the “Platform” setting of the digital camera 100, the file management portion 110 performs, with respect to the downloaded application or data, processing that specifies that the application or data is not manageable by the digital camera 100 (step S108).

The digital camera 100 according to the embodiment of the present disclosure performs the series of processing shown in FIG. 6, and can thus store the downloaded application or data inside the digital camera 100 in accordance with the content of the metadata that is attached to the application or data.

The storage of the downloaded application or data inside the digital camera 100, which is performed by the digital camera 100 according to the embodiment of the present disclosure, will be explained in more detail with reference to the drawings.

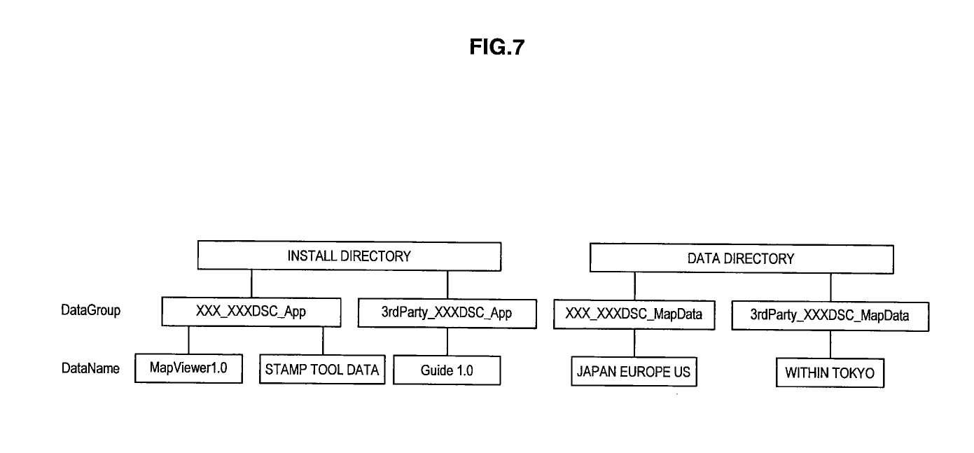

FIG. 7 is an explanatory diagram showing a directory structure of the digital camera 100 according to the embodiment of the present disclosure. The directory structure shown in FIG. 7 is a directory structure that is used when there is no limitation on “IDGroup” and “Platform”, and “Platform” and “Group” are locally managed. This directory structure corresponds to a case in which the “GlobalMode” meta information is 0.

FIG. 7 shows a case in which there are two types of “IDGroup”, which are “XXX” and “3rdParty”, and “Platform” is “XXXDSC”. Further, one of “App” and “MapData” is specified as “Group” meta information.

In this case, under an application install directory, an “XXX_XXXDSC_App” directory or an “XXX_{—}3rdParty_App” directory is created by the file management portion 110. Further, under a data directory, an “XXX_XXXDSC_MapData” directory or an “XXX_{—}3rdParty_MapData” directory is created by the file management portion 110.

When there is no limitation on “IDGroup” and “Platform” and in addition, “Platform” and “Group” are locally managed, the file management portion 110 creates, directly below the application install directory and the data directory, directories that are each formed by combining the three elements “IDGroup”, “Platform” and “Group” using the under bars “_”. Then, directly below the created directories, the file management portion 110 creates directories formed of the “Name” element.

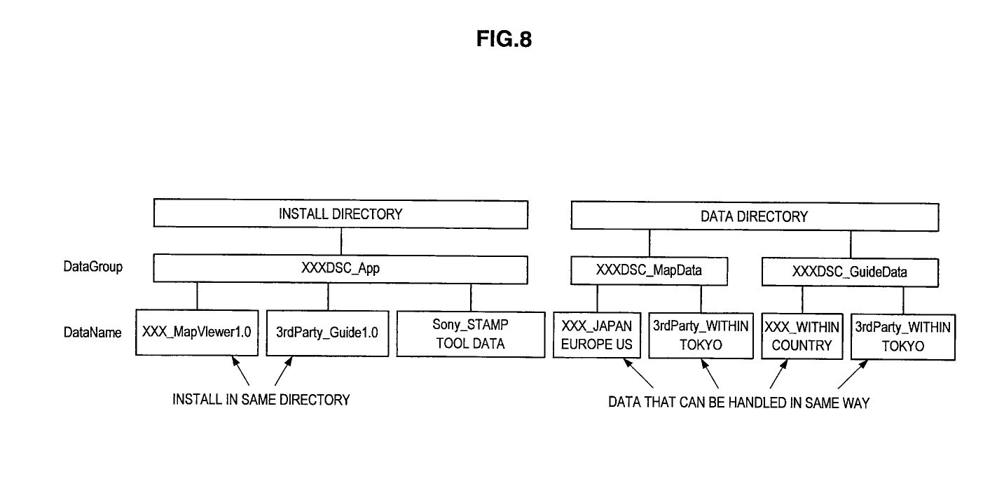

FIG. 8 is an explanatory diagram showing a directory structure of the digital camera 100 according to the embodiment of the present disclosure. The directory structure shown in FIG. 8 is a directory structure that is used when there is no limitation on “IDGroup” and “Platform”, and “Platform” and “Group” are globally managed. This directory structure corresponds to a case in which the “GlobalMode” meta information is 1. Here, the directory in which “Platform” is “XXXDSC” and the directory in which “Group” is “App” are globally managed.

In this case, under the application install directory, an “XXXDSC_App” directory is created by the file management portion 110. Further, under the data directory, an “XXXDSC_MapData” directory or an “XXXDSC_GuideData” directory is created by the file management portion 110.

Then, under the “XXXDSC_App” directory, an “XXX_MapViewer1.0” directory and a “3rdParty_Guide1.0” directory are created by the file management portion 110. Thus, applications in which the element “Group” belongs under “App” are collectively stored in the “XXXDSC_App” directory.

When there is no limitation on “IDGroup” and “Platform” and in addition, “Platform” and “Group” are globally managed, the file management portion 110 creates, directly below the application install directory and the data directory, directories that are each formed by combining the two elements “Platform” and “Group” using the under bar “_”. Then, directly below the created directories, the file management portion 110 creates directories that are each formed by combining the two elements “IDGroup” and “Name” using the under bar “_”.

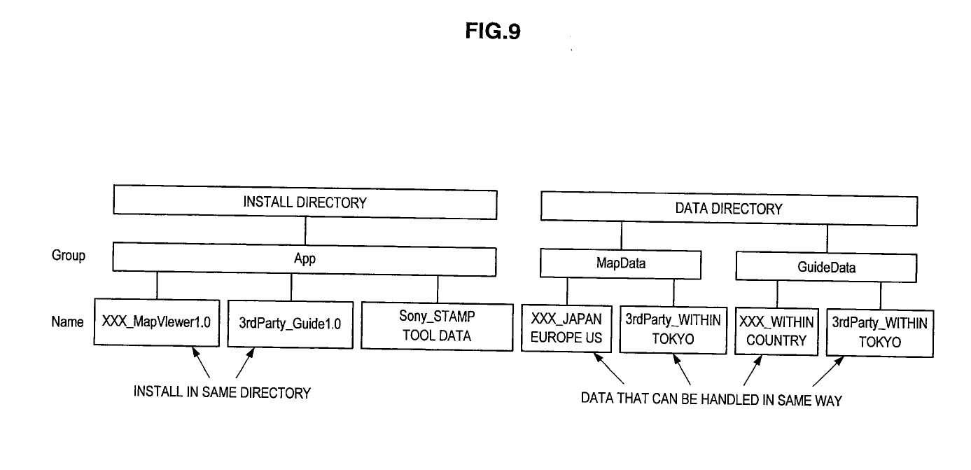

FIG. 9 is an explanatory diagram showing a directory structure of the digital camera 100 according to the embodiment of the present disclosure. The directory structure shown in FIG. 9 is a directory structure that is used when there is a limitation on “Platform” only and “Group” is globally managed. This directory structure corresponds to a case in which the “GlobalMode” meta information is 3.

In this case, under the application install directory, an “App” directory is created by the file management portion 110. Further, under the data directory, a “MapData” directory or a “GuideData” directory is created by the file management portion 110.

Then, under the “App” directory, the “XXX_MapViewer1.0” directory and the “3rdParty_Guide1.0” directory are created by the file management portion 110. Thus, applications in which the element “Group” belongs under “App” are collectively stored in the “App” directory.

When there is a limitation on “Platform” only and in addition, “Group” is globally managed, the file management portion 110 creates, directly below the application install directory and the data directory, directories that are each formed of the single element “Group”. Then, directly below the created directories, the file management portion 110 creates directories formed by combining the two elements “IDGroup” and “Name” using the under bar “_”.

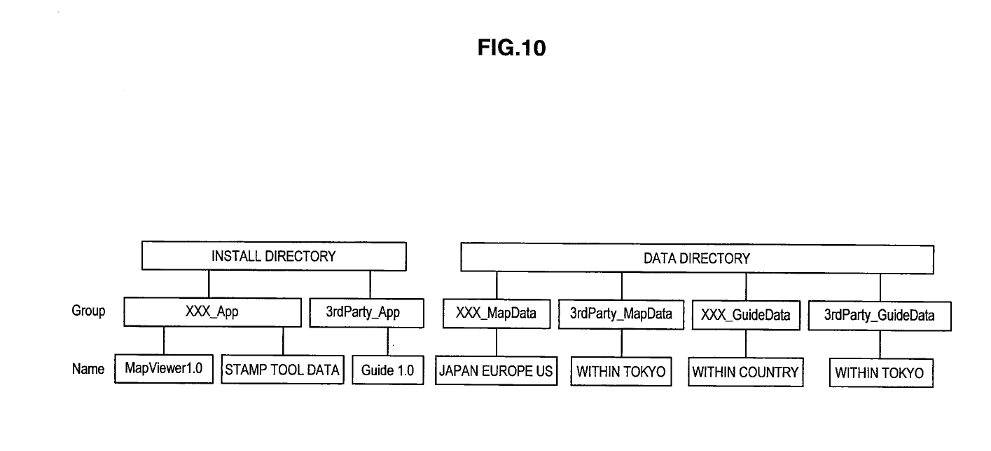

FIG. 10 is an explanatory diagram showing a directory structure of the digital camera 100 according to the embodiment of the present disclosure. The directory structure shown in FIG. 10 is a directory structure that is used when there is a limitation on “Platform” only and “Group” is locally managed. This directory structure corresponds to a case in which the “GlobalMode” meta information is 2.

In this case, under the application install directory, an “XXX App” directory and a “3rdParty_App” directory are created by the file management portion 110. Further, under the data directory, an “XXX_MapData” directory, an “XXX_GuideData” directory, a “3rdParty_MapData” directory and a “3rdParty_GuideData” directory are created by the file management portion 110.

Then, a “MapViewer1.0” directory is created under the “XXX_App” directory, and a “Guide1.0” directory is created under the “3rdParty_App” directory by the file management portion 110.

When there is a limitation on “Platform” only and in addition, “Group” is locally managed, the file management portion 110 creates, directly below the application install directory and the data directory, directories that are each formed by combining the two elements “IDGroup” and “Group” using the under bar “_”. Then, directly below the created directories, the file management portion 110 creates directories formed of the single element “Name”.

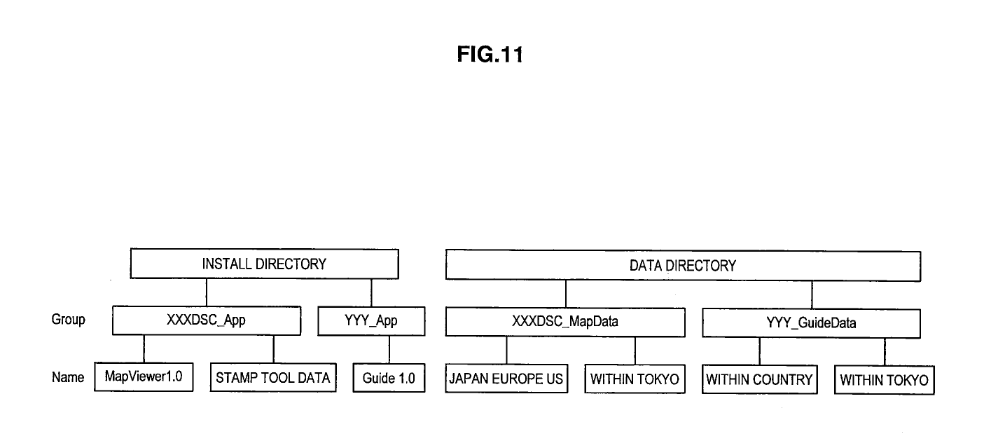

FIG. 11 is an explanatory diagram showing a directory structure of the digital camera 100 according to the embodiment of the present disclosure. The directory structure shown in FIG. 11 is a directory structure that is used when there is a limitation on “IDGroup” only. This directory structure corresponds to a case in which the “GlobalMode” meta information is 4.

In this case, under the application install directory, an “XXXDSC App” directory and a “YYY_App” directory are created by the file management portion 110. Further, under the data directory, an “XXXDSC_MapData” directory and a “YYY_GuideData” directory are created by the file management portion 110.

Then, the “MapViewer1.0” directory is created under the “XXXDSC_App” directory, and the “Guide1.0” directory is created under the “YYY_App” directory by the file management portion 110.

When there is a limitation on “IDGroup” only, the file management portion 110 creates, directly below the application install directory and the data directory, directories that are each formed by combining the two elements “Platform” and “Group” using the under bar “_”. Then, directly below the created directories, the file management portion 110 creates directories formed of the single element “Name”.

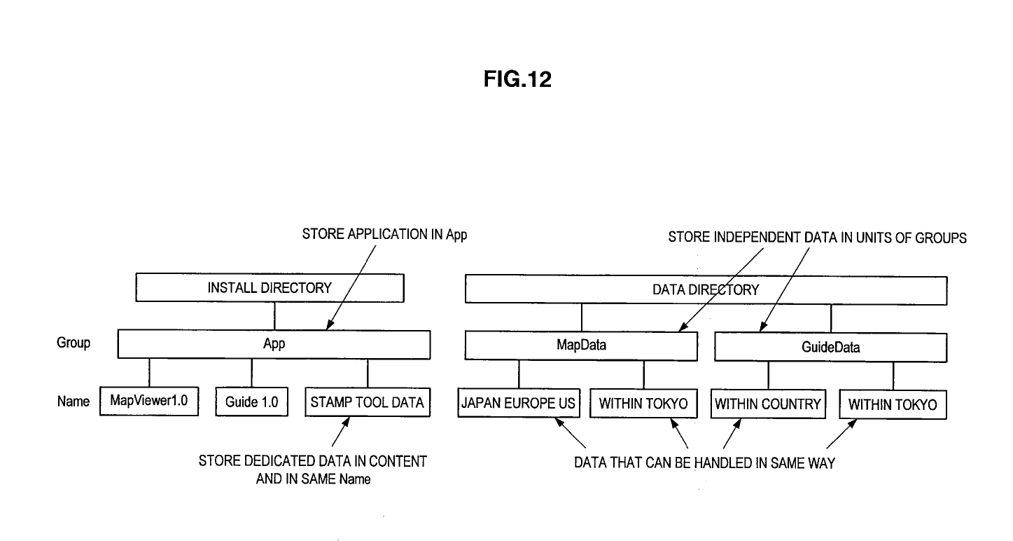

FIG. 12 is an explanatory diagram showing a directory structure of the digital camera 100 according to the embodiment of the present disclosure. The directory structure shown in FIG. 12 is a directory structure that is used when there is a limitation on “IDGroup” and “Platform”. This directory structure corresponds to a case in which the “GlobalMode” meta information is 6.

In this case, under the application install directory, the “App” directory is created by the file management portion 110. Further, under the data directory, the “MapData” directory and the “GuideData” directory are created by the file management portion 110.

Then, under the “App” directory, the “MapViewer1.0” directory and the “Guide1.0” directory are created by the file management portion 110. When there is a limitation on “IDGroup” and “Platform”, all the applications are stored under the “App” directory in this manner. Content data are stored under the “MapData” directory and under the “GuideData” directory.

When there is a limitation on “IDGroup” and “Platform”, the file management portion 110 creates, directly below the application install directory and the data directory, directories that are each formed of the single element “Group”. Then, directly below the created directories, the file management portion 110 creates directories formed of the single element “Name”.

In this manner, when an application or data is installed in accordance with the content of the “GlobalMode” meta information, the file management portion 110 creates a directory by changing the structure and it is thus possible to store the application or content data in the created directory. As a result, the same or the same type of application or content data can be collectively stored in the same directory, and it is thus possible for the digital camera 100 according to the embodiment of the present disclosure to more easily manage the applications and data.

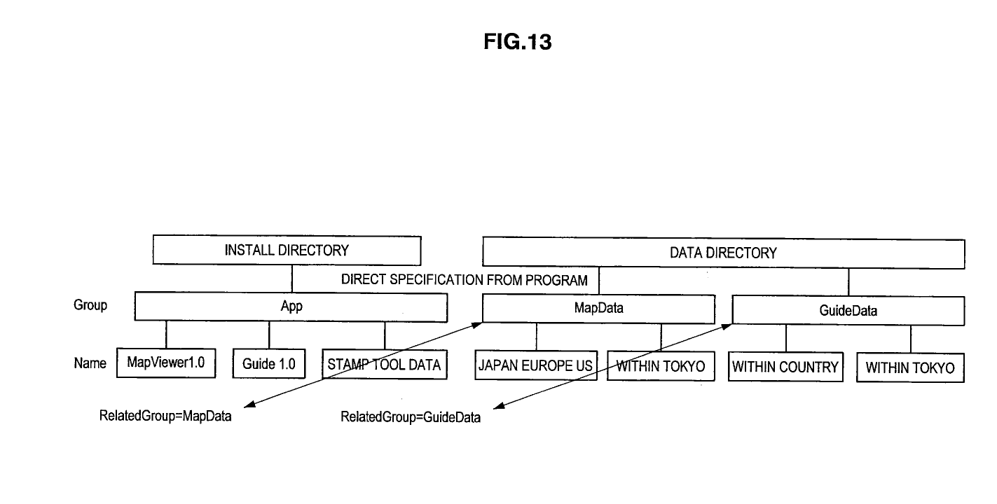

Next, an example will be explained in which the application stored in the application install directory uses the data stored in the data directory. FIG. 13 is an explanatory diagram showing a directory structure of the digital camera 100 according to the embodiment of the present disclosure.

When the application stored in the application install directory uses the data stored in the data directory, the digital camera 100 refers to the content of “RelatedGroup” meta information included in the metadata that is attached to the application.

A specific explanation will be made using FIG. 13. For example, when “MapViewer1.0” refers to the data under the “MapData” directory, metadata described as “MapData” is prepared in advance in “RelatedGroup”, and “MapViewer1.0” utilizes “MapData” described in “RelatedGroup”. In a similar manner, when “GuideData1.0” refers to the data under the “GuideData” directory, metadata described as “GuideData” is prepared in advance in “RelatedGroup”, and “GuideViewer1.0” utilizes “GuideData” described in “RelatedGroup”.

In this manner, the application and the content are connected by the “RelatedGroup” meta information. Thus, the application stored in the application install directory can use the data stored in the data directory. If the “RelatedGroup” meta information is applied, it is possible to access a plurality of data directories from one application, and it is also possible for a plurality of applications to use one directory. Further, when performing a version upgrade, which will be described later, if the content of the “RelatedGroup” meta information is updated, it is also possible to use data that is stored in a directory that is added later.

Next, a version upgrade example of the application or content data will be explained. The version upgrade of the application or content data includes a minor version upgrade and a major version upgrade. In the present embodiment, the minor version upgrade does not involve changes of “Group” and “Name”, and the application or a data file only is replaced or added. “DataVersion” meta information is used to indicate a difference between versions.

On the other hand, the major version upgrade involves changes of “Group” and “Name”. For example, in the case of the application, a “Name” element different from that of an old version is used, and a directory different from that of the old version is created. In the case of the content data, a “Group” element different from that of an old version is used, and a directory different from that of the old version is created. Therefore, files of both the new and old versions exist simultaneously. Then, “OldVersion” meta information is used as a link to a previous version. The “OldVersion” meta information is not metadata used to manage applications and data, and it is included in metadata used to manage a service to provide applications and data. As a matter of course, when performing a version upgrade, the directories of the old version may be deleted.

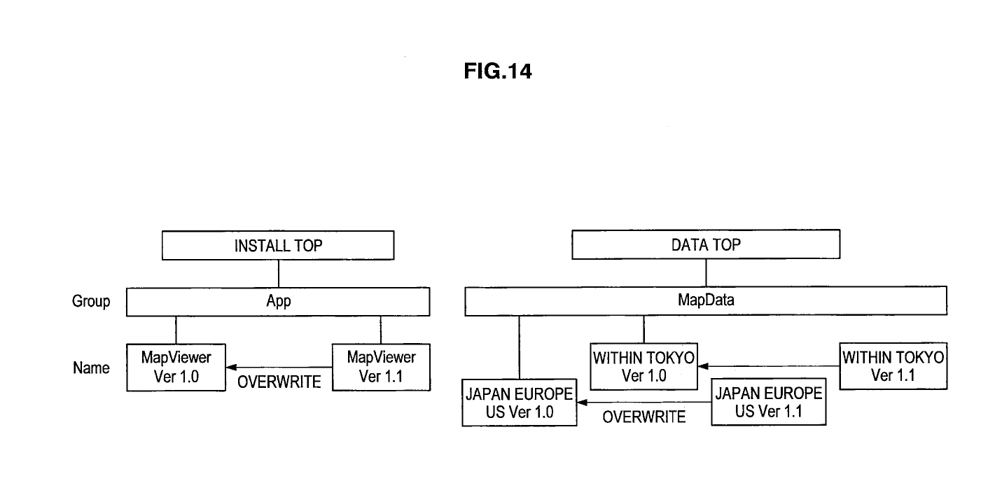

FIG. 14 is an explanatory diagram showing a directory structure of the digital camera 100 according to the embodiment of the present disclosure. The example shown in FIG. 14 is a directory structure that is used when performing a minor version upgrade of an application and content data. In this manner, in the minor version upgrade of the application and content data, the application and data files only are replaced or added.

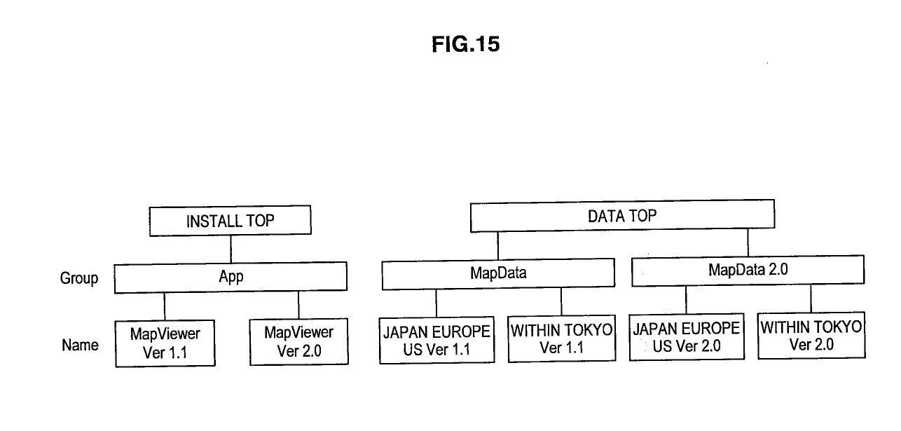

FIG. 15 is an explanatory diagram showing a directory structure of the digital camera 100 according to the embodiment of the present disclosure. The example shown in FIG. 15 is a directory structure that is used when performing a major version upgrade of an application and content data. In this manner, in the major version upgrade of the application and content data, directories different from those of the old version are created and new versions of the application and data files only are stored in the newly created directories.

In this manner, in the version upgrade of the application and content data, the digital camera 100 according to the embodiment of the present disclosure can change a file storage method when performing the version upgrade, depending on whether the version upgrade is the minor version upgrade or the major version upgrade.

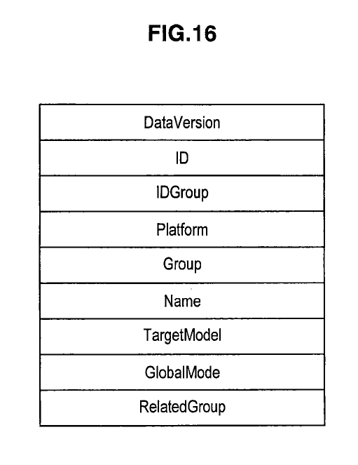

Next, a configuration example of the metadata that is attached to the application or content data and transmitted from the application download server 10 or from the content download server 20 will be explained. FIG. 16 is an explanatory diagram showing a configuration example of the metadata that is transmitted from the application download server 10 or from the content download server 20.

FIG. 16 shows the metadata configuration that includes “DataVersion”, “ID”, “IDGroup”, “Platform”, “Group”, “Name”, “TargetMode1”, “GlobalMode” and “RelatedGroup”.

“DataVersion” is meta information describing the version of the application or data, and it is referred to when performing the version upgrade of the application or data in the digital camera 100, as described above. “ID” is meta information describing an ID that is formed by combining the four elements “IDGroup”, “Platform”, “Group” and “Name” using the under bars “_”, and “ID” is used to store the whole ID. “TargetMode1” meta information will be described in detail later.

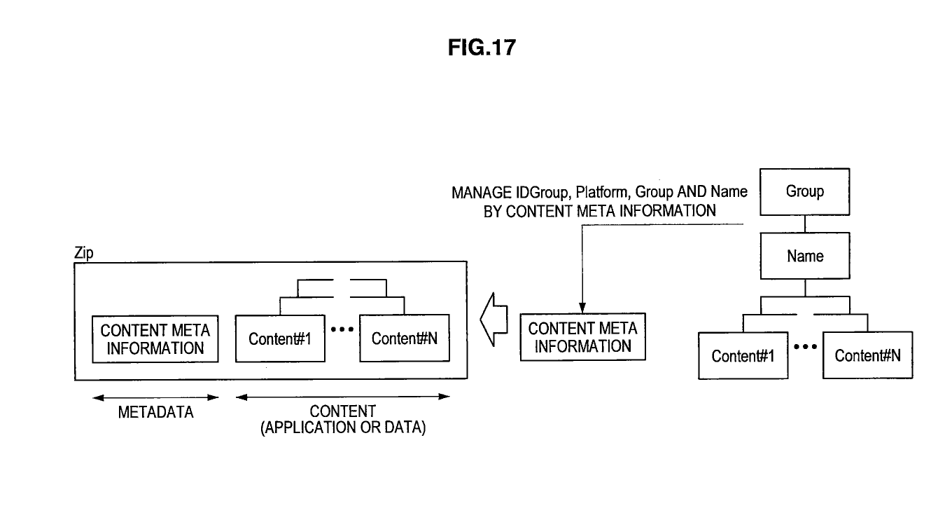

FIG. 17 is an explanatory diagram showing an example of content of an application or data transmitted from the application download server 10 or from the content download server 20. As described above, in the present embodiment, the four elements “IDGroup” “Platform” “Group” and “Name” are managed by metadata (content meta information). Accordingly, if the application or content data and the metadata are compressed and held in the application download server 10 or the content download server 20, the digital camera 100 can acquire the content meta information attached to the application or data at the same time that the digital camera 100 downloads the application or data.

Next, an explanation will be made of a management method that is used when the application or data transmitted from the application download server 10 or the content download server 20 is different for each device.

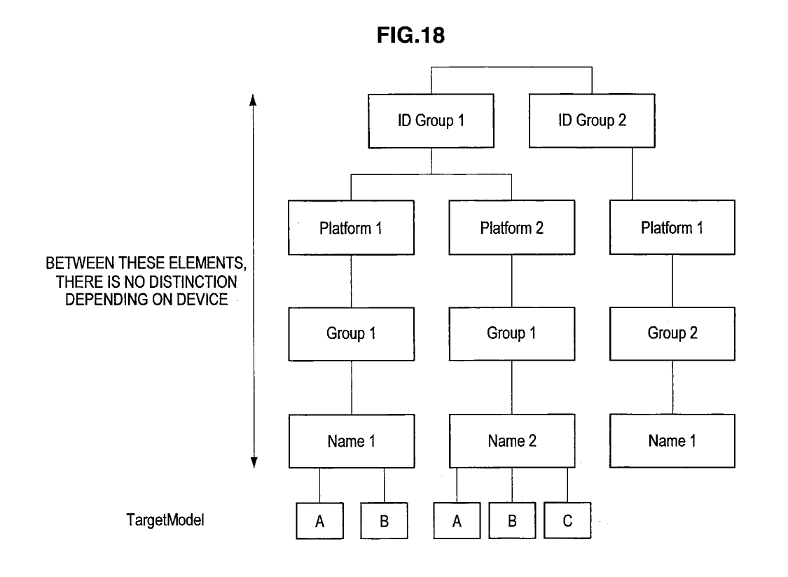

FIG. 18 is an explanatory diagram showing an example of a structure of the metadata that is used in the information processing system 1 according to the embodiment of the present disclosure. In the structure of the metadata shown in FIG. 18, a new element “TargetMode1” is added to the metadata structure shown in FIG. 3. “TargetMode1” is an element that is used to indicate that applications (content items) are handled in a same way when different device models are all managed by different IDs.

For example, even with the same application, there is a case in which details have to be changed due to a difference in hardware performance of the device on which the application is executed. For example, a case is conceivable in which the content of display should be changed depending on whether the screen is a touch panel or not. In this type of case, even with the same application, different binary data is prepared corresponding to a target device on which the application is executed. By doing this, it is possible to simplify the management of the application and data. Note that an exclusive limitation is imposed such that a plurality of different “TargetMode1” elements cannot exist in a same device.

In FIG. 18, under “IDGroup1”-“Platform1”-“Group1”-“Name1”, “A” and “B” are specified as “TargetMode1”. Further, under “IDGroup 1”-“Platform2”-“Group1”-“Name2”, “A” and “B” are specified as “TargetMode1”.

Note that the “TargetMode1” meta information is used when the application or data is distributed to each device from the application download server 10 or the content download server 20. The “TargetMode1” meta information is not used for directory creation and file storage after the application or data has been distributed to each device. When the application or data does not vary depending on the device, the content of the “TargetMode1” meta information may of course be omitted.

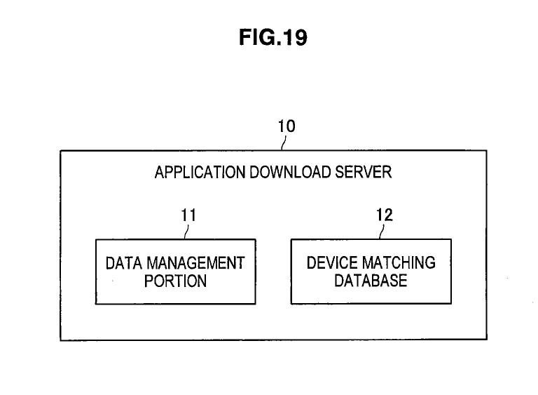

FIG. 19 is an explanatory diagram showing a functional configuration example of the application download server 10 according to the embodiment of the present disclosure. Hereinafter, the functional configuration example of the application download server 10 according to the embodiment of the present disclosure will be explained with reference to FIG. 19.

As shown in FIG. 19, the application download server 10 according to the embodiment of the present disclosure is provided with a data management portion 11 and a device matching database 12.

The data management portion 11 manages applications that are provided from the application download server 10, using IDs that are each formed by the five elements “IDGroup”, “Platform” “Group” “Name” and “TargetMode1”. When a download request of a target application is transmitted from a client device, the data management portion 11 searches the device matching database 12 for an application that is appropriate for each device, and provides the appropriate application.

The device matching database 12 is a database in which application information is registered for each device. When a download request of a target application is transmitted from a client device, the data management portion 11 refers to the information registered in the device matching database 12 and can thus provide an application that is appropriate for each device.

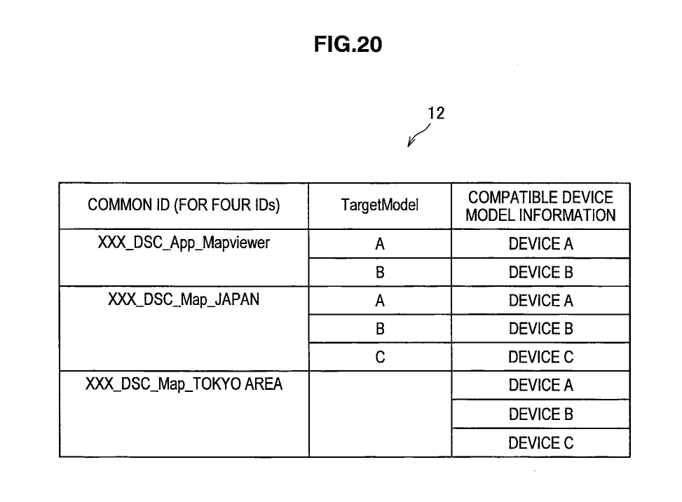

Hereinabove, the functional configuration example of the application download server 10 according to the embodiment of the present disclosure is explained with reference to FIG. 19. Next, an example of content of the device matching database 12 will be explained. FIG. 20 is an explanatory diagram showing an example of content of the device matching database 12.

In the device matching database 12 shown in FIG. 12, three IDs “XXX_DSC_App_Mapviewer”, “XXX_DSC_Map_Japan” and “XXX_DSC_Map_Tokyo Area” are shown as common IDs that are each formed by the elements “IDGroup”, “Platform” “Group” and “Name”. “XXX_DSC_App_Mapviewer” indicates an ID of a map display application that is executed by the digital camera 100, for example. “XXX_DSC_Map_Japan” indicates an ID of a map of Japan that is used by the map display application. “XXX_DSC_Map Tokyo Area” indicates an ID of a Tokyo area map that is used in the map display application.

Among these, with respect to “XXX_DSC_App_Mapviewer” and “XXX_DSC_Map_Japan”, “TargetMode1” is specified. Since “TargetMode1” is specified, it is indicated that different applications or data are prepared for each of the devices. On the other hand, “TargetMode1” is not specified with respect to “XXX_DSC_Map_Tokyo Area”. This indicates that common data is prepared for all the devices that execute the map display application.

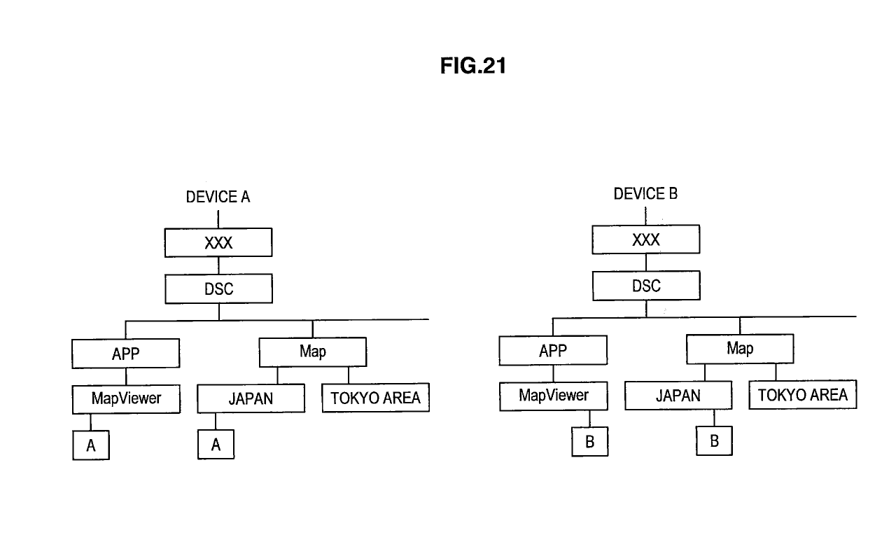

FIG. 21 is an explanatory diagram showing a hierarchical structure that is used when providing an application and data to client devices. The hierarchical structure shown in FIG. 21 is a hierarchical structure that is used when data is registered in the device matching database 12 as shown in FIG. 20.

When the above-described map display application is provided to a device A (for example, a digital camera having a display portion that is provided with a touch panel), an application and data that are created for the device A are provided as the map display application and data of the map of Japan that is used by the map display application. When the above-described map display application is provided to a device B (for example, a digital camera having a display portion that is not provided with a touch panel), an application and data that are created for the device B are provided as the map display application and data of the map of Japan that is used by the map display application. Data that is common to the device A and the device B is provided as data of the Tokyo area map that is used by the map display application.

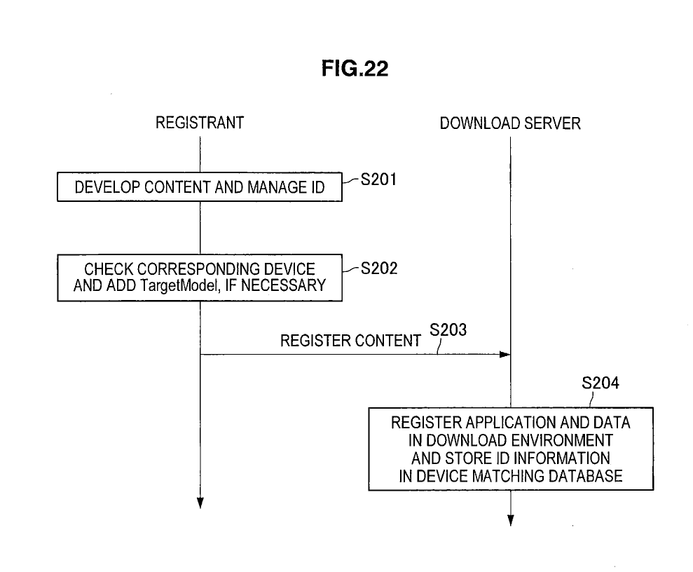

Next, a flow of processing between a content registrant and a download server, in the information processing system 1 according to the embodiment of the present disclosure, will be explained. FIG. 22 is a flowchart showing the flow of the processing between the content registrant and the download server, in the information processing system 1 according to the embodiment of the present disclosure.

The content registrant who creates an application and data and registers them on the download server develops the application and data. Further, the content registrant manages IDs that are each attached to the application and data and that are each formed by the four elements “IDGroup” “Platform” “Group” and “Name” (step S201).

Next, the content registrant creates a device list that corresponds to the created application and data. Here, if different application binaries or different data are used for each of the devices, the “TargetMode1” element is added to the ID (step S202).

When the content registrant has developed the application and data and has completed the ID management, the content registrant registers the created application and data together with their IDs on the download server (the application download server 10 and the content download server 20 are collectively referred to as the “download server”) (step S203).

The download server registers the application and data registered by the content registrant in a download environment, and at the same time, the download server stores ID information in the device matching database 12 (step S204). As a result of the series of processing, the application and data developed by the content registrant can be downloaded from the client devices.

Hereinabove, the flow of the processing between the content registrant and the download server, in the information processing system 1 according to the embodiment of the present disclosure, is explained with reference to FIG. 22. Next, a flow of processing between the client device (for example, the digital camera 100) and the download server, in the information processing system 1 according to the embodiment of the present disclosure, will be explained.

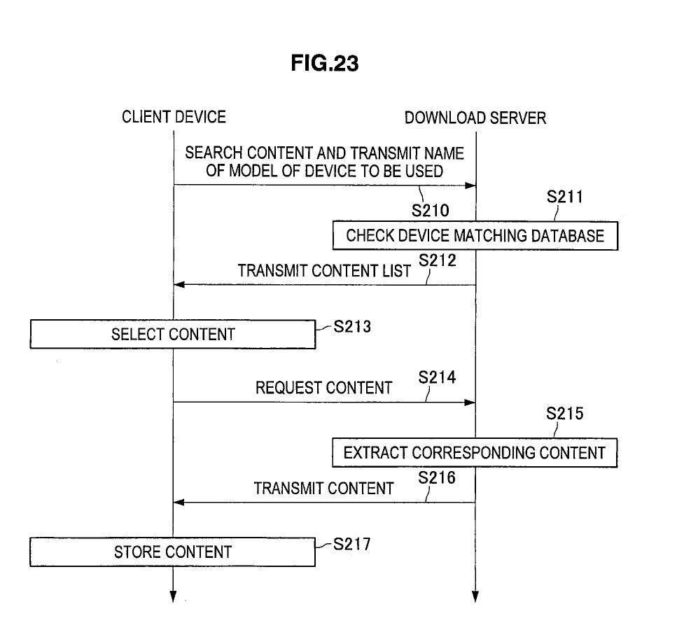

FIG. 23 is a flowchart showing a flow of processing between a client device and the download server, in the information processing system 1 according to the embodiment of the present disclosure. Hereinafter, the flow of the processing between the client device and the download server, in the information processing system 1 according to the embodiment of the present disclosure, will be explained with reference to FIG. 23.

When the client device acquires an application and data from the download server, first, the client device logs in to the download server and performs a content search and transmission of a name of a model of the device to be used (step S210). Information of the name of the model of the device to be used, which is transmitted by the client device to the download server, corresponds to the “TargetMode1” element.

When the client device performs the content search and the transmission of the device information to the download server at step S210 described above, the download server checks the device matching database 12, using the information transmitted from the client device (step S211). After checking the device matching database 12, the download server transmits to the client device a content list that matches the request made at step S210 (step S212).

When the client device receives the content list from the download server, the client device selects an application and data to be downloaded (step S213), and requests the download server to download the selected application and data (step S214).

When the client device requests the download server to download the application and data at step S214 described above, the download server extracts a corresponding application and data (step S215) and transmits the extracted application and data to the client device (step S216).

When the client device receives the application and data from the download server, the client device stores the application and data internally, in accordance with the above-described storing rule (step S217). When the client device stores the application and data internally, the client device does not use information of the “TargetMode1” element.

Since the processing is performed in this manner between the client device and the download server, even if the content of the application and data is partially different for each device, an application and data appropriate for the client device can be provided from the download server to the client device. When the client device stores the application and data internally, the client device performs the above-described directory creation using the four elements “IDGroup” “Platform” “Group” and “Name”, without taking into consideration differences in the “TargetMode1” element.

Hereinabove, the flow of the processing between the client device and the download server, in the information processing system 1 according to the embodiment of the present disclosure, is explained with reference to FIG. 23. Next, a flow of content registration by the content registrant will be explained.

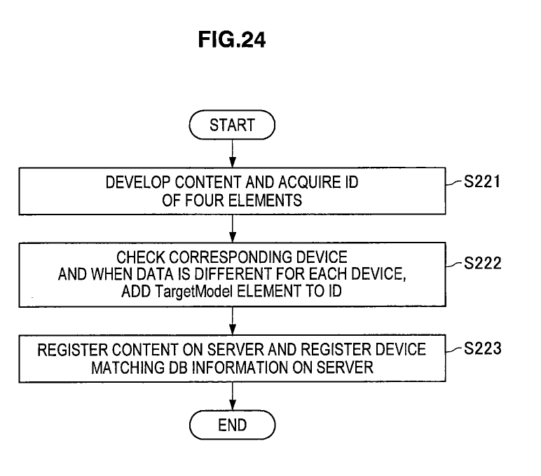

FIG. 24 is a flowchart showing a flow of content registration by the content registrant, in the information processing system 1 according to the embodiment of the present disclosure. Hereinafter, the flow of the content registration by the content registrant, in the information processing system 1 according to the embodiment of the present disclosure, will be explained with reference to FIG. 24.

The content registrant who creates an application and data and registers them on the download server develops the application and data. Further, the content registrant acquires IDs that are each attached to the application and data and that are each formed by the four elements “IDGroup” “Platform” “Group” and “Name” (step S221).

Next, the content registrant creates a device list that corresponds to the created application and data. Here, if different application binaries or different data are used for each of the devices, the “TargetMode1” element is added to the ID (step S222).

When the content registrant has developed the application and data and has completed the ID management, the content registrant registers the created application and data together with their IDs on the download server (the application download server 10 and the content download server 20 are collectively referred to as the “download server”) (step S223). As a result of the series of processing, the application and data developed by the content registrant can be downloaded from the client devices.

Hereinabove, the flow of the content registration by the content registrant, in the information processing system 1 according to the embodiment of the present disclosure, is explained with reference to FIG. 24. Next, a flow of content search and acquisition processing by the client device, in the information processing system 1 according to the embodiment of the present disclosure, will be explained.

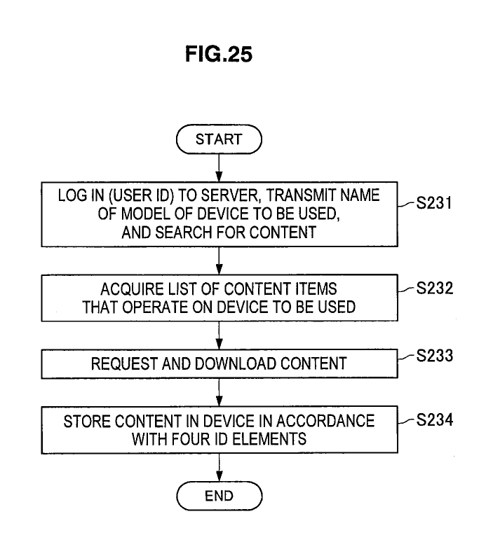

FIG. 25 is a flowchart showing a flow of content search and acquisition processing by the client device, in the information processing system 1 according to the embodiment of the present disclosure. Hereinafter, the flow of content search and acquisition processing by the user, in the information processing system 1 according to the embodiment of the present disclosure, will be explained with reference to FIG. 25.

When the user acquires, from the download server, the application and data to be used in the client device, first, the user logs in to the download server, transmits a name of a model of the device to be used, and searches for the application and data (step S231). The login and the search processing may be performed using the client device. Information of the name of the model of the device to be used, which is transmitted by the user to the download server, corresponds to the “TargetMode1” element.

Next, the user acquires, from the download server, a list of content items that operate on the client device to be used (step S232). The acquisition processing may be performed using the client device.

When the list of the content items that operate on the client device to be used is acquired from the download server, then, the user requests the application and data from the download server, and the user downloads the application and data from the download server (step S233). The request and the download processing may be performed using the client device.

Next, the user stores the application and data downloaded from the download server, in the client device, in accordance with the four elements “IDGroup” “Platform” “Group” and “Name” (step S234). The storage processing is performed by the client device.

Hereinabove, the flow of the content search and the acquisition processing by the user, in the information processing system 1 according to the embodiment of the present disclosure, is explained with reference to FIG. 25. Next, content search and transmission processing by the download server, in the information processing system 1 according to the embodiment of the present disclosure, will be explained.

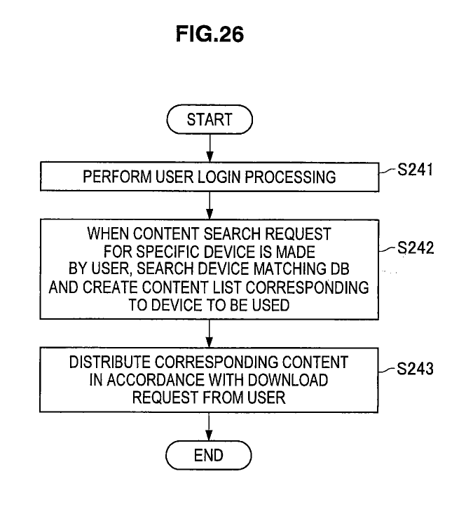

FIG. 26 is a flowchart showing content search and transmission processing by the download server, in the information processing system 1 according to the embodiment of the present disclosure. Hereinafter, the content search and the transmission processing by the download server, in the information processing system 1 according to the embodiment of the present disclosure, will be explained with reference to FIG. 26.

When a login request is made by the user, the download server performs login processing of the user (step S241). When the login processing is complete and a content search request for a specific device is made by the user, the download server searches the device matching database 12, creates a content list corresponding to the device to be used by the user, and provides the content list to the user (step S242).

After that, when a download request for an application and data is transmitted from the user, the download server distributes the application and data corresponding to the device to be used by the user, in accordance with the download request from the user (step S243).

Hereinabove, the content search and the transmission processing by the download server, in the information processing system 1 according to the embodiment of the present disclosure, is explained with reference to FIG. 26. In this manner, even with the same application, different binary data is prepared corresponding to a target device on which the application is executed. Thus, it is possible to simplify the management of the application and data on the download server side. The client device that downloads the application and data can automatically acquire the application and data appropriate for the device itself from the download server, by simply transmitting the device information to the download server. With respect to content that is purchased by a certain user, even if a compatible device is different, as long as corresponding content is the same, management that allows re-download of the corresponding content becomes possible.

Note that, in the above-described processing, a working example is explained in which an application and content data are selected, and download of the selected application and content data is caused to be performed by the digital camera 100. However, the present disclosure is not limited to this example. For example, a personal computer, a smart phone or the like may be used to select an application and content data, and may be allowed to download the selected application and content data. Then, the downloaded application and data may be transferred to a digital camera from the personal computer, the smart phone or the like.

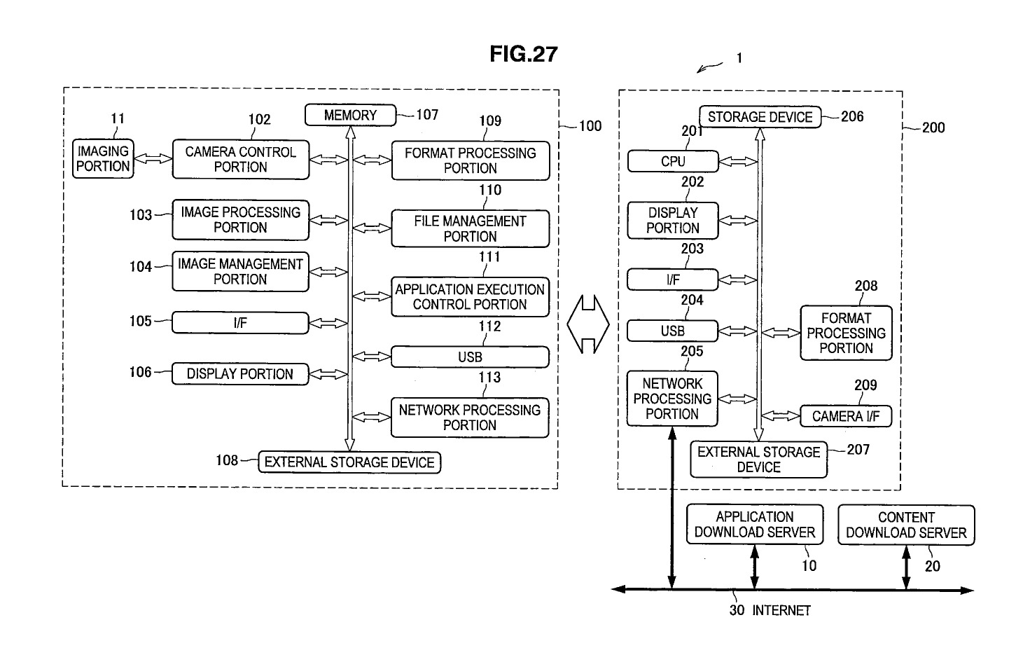

FIG. 27 is an explanatory diagram showing a system configuration example of the information processing system 1 according to the embodiment of the present disclosure. The system configuration example of the information processing system 1 shown in FIG. 27 is obtained by adding a personal computer 200 to the configuration shown in FIG. 2.

As shown in FIG. 27, the personal computer 200 is provided with a CPU 201, a display portion 202, an I/F 203, a USB 204, a network processing portion 205, a storage device 206, an external storage device 207, a format processing portion 208 and a camera I/F 209.

The CPU 201 functions as a calculation processing device and a control portion. The CPU 201 controls overall operations in the personal computer 200 or part of the operations, in accordance with various programs stored in the personal computer 200. The display portion 202 is a CRT display device, a liquid crystal display device, a plasma display device, an organic EL display device, or the like. The display portion 202 displays, as a text or an image, a result obtained by various types of processing performed by the personal computer 200.

The I/F 203 is an interface to connect peripheral devices to the personal computer 200. The USB 204 is an interface to connect the personal computer 200 and another device (for example, the digital camera 100) using a USB cable. The network processing portion 205 performs connection processing to the Internet 30. The personal computer 200 can download an application and data from the application download server 10 and the content download server 20 that are connected to the Internet 30 by the connection processing to the Internet 30 performed by the network processing portion 205.

The external storage device 207 is, for example, a magnetic storage device, such as a hard disk drive (HDD), a semiconductor storage device, an optical storage device, a magneto-optical storage device, or the like. The external storage device 207 stores programs and various types of data that are executed by the CPU 201, and acoustic signal data and image signal data that are acquired from the outside.

In a similar manner to the format processing portion 109, the format processing portion 208 analyzes the content of the metadata that is attached to the application downloaded from the application download server 10 or to the content downloaded from the content download server 20. The format processing portion 208 analyzes the content of the metadata and controls file management, by the file management portion 110, of the application downloaded from the application download server 10 and the content data downloaded from the content download server 20. The camera 1/F 209 is an interface to perform transmission and reception of information while being connected to the digital camera 100.

When the digital camera 100 and the personal computer 200 are configured in this manner, the personal computer 200 can analyze the content of the metadata attached to the content, and based on the analyzed content, the personal computer 200 can control storage of the application and the data into the digital camera 100.

### 3. Conclusion

As explained above, according to the embodiment of the present disclosure, when an application and data are downloaded from the application download server 10 and the content download server 20 and are stored in the digital camera 100, the digital camera 100 analyzes the metadata attached to the application and the data. Then, in accordance with a result of the analysis of the metadata, the digital camera 100 changes the directory structure to store the application and the data.

In this manner, the directory structure to store the application and the data is changed in accordance with the result of the analysis of the metadata, thus achieving two-layer directory management in which the directory structures do not conflict.

Further, the global specification is performed for a predetermined element of the ID. Thus, grouping management across the “IDGroup” element becomes possible, and group management becomes possible in the two-layer directory management. Further, even when the global specification is not performed, the directories are separated by “IDGroup” and thus directory structures do not conflict.

Further, since a limitation is specified for a predetermined element, when the user wants exclusive use, a simplified directory management method can be provided. At the same time, it is possible to achieve handling of many types in a separate manner using the same format, handling of necessary portions by grouping, and handling of the directory structure that is simplified by imposing a limitation.

Further, according to the embodiment of the present disclosure, even with the same application or data, if the binaries are different depending on the device model, the application or data is managed by the “TargetMode1” element for each of the binaries. Thus, it is possible to automatically select a corresponding binary when the application or data is provided to the client device.

Before installation in the client device, the processing by the ID management that includes “TargetMode1” is performed so that a difference for each of the binaries can be handled. After installation in the client device, exclusive “TargetMode1” is not necessary, and it is possible to achieve a management method in which the four elements from “IDGroup” to “Name” are used and the binary difference is not noticed. By handling the binaries in this manner, it is possible to conceal the binary difference caused by differences in device model and it is possible to handle the binaries as if they are the same application or data. Further, the application and the data that can be handled in a same way have a same file structure and a common access path to the application and data can be used. Thus, the management of the application and the data becomes easy.

Hereinabove, the exemplary embodiment of the present disclosure is explained in detail with reference to appended drawings. However, the present disclosure is not limited to the above-described examples. It should be understood by those skilled in the art that various modifications, combinations, sub-combinations and alterations may occur depending on design requirements and other factors insofar as they are within the scope of the appended claims or the equivalents thereof.

For example, if “Group” of the application that includes an execution routine is specified as “App”, execution applications can be collected under the same group directory. Further, when applications are managed, if executable applications are grouped into a same directory, it is possible to achieve higher speed processing and simplified management.

Then, if “App” is globally specified, even when other manufacturer's applications are used as “IDGroup”, it is possible to collect the applications as executable applications in the same “Group” that is executable and to manage them.

Further, for example, when it is assumed that various types of data are added to content data (for example, a map, a magazine or a book) that can be handled using the same application, if the same “Group” is specified, it is possible to handle the content data as the same data, or it is possible to execute the content data using the same application.

Furthermore, even with other manufacturer's content whose “IDGroup” is different, if it can be handled by the same application, the content can be handled as the same “Group” by global specification, and common use between manufacturers becomes possible.

Moreover, for example, when the application that has been purchased is re-distributed to another device, if the application and data have the same four elements from “IDGroup” to “Name” and can be handled in the same way, even if the binary is different, the binary of “TargetMode1” corresponding to a new device model can be automatically provided from the download server when a re-distribution request is made by the client device.

Additionally, the present technology may also be configured as below.

(1) An information processing device including:

a metadata reception portion that receives metadata that is attached to content data and transmitted;

a metadata analysis portion that analyzes the metadata received by the metadata reception portion; and

a content data storage portion that determines a storage method of the content data based on a result of the analysis by the metadata analysis portion;

wherein

based on the analysis by the metadata analysis portion, the content data storage portion changes a directory structure when storing the content data, in accordance with a content of a predetermined element of the metadata received by the metadata reception portion.

(2) The information processing device according to (1), wherein

based on the analysis by the metadata analysis portion, the content data storage portion changes the directory structure when storing the content data, in accordance with whether a predetermined element of the metadata is limited to being used in the information processing device itself.

(3) The information processing device according to (1) or (2), wherein

based on the analysis by the metadata analysis portion, the content data storage portion changes the directory structure when storing the content data, in accordance with whether a predetermined element of the metadata is used in common between elements of a higher hierarchy than the predetermined element.

(4) The information processing device according to any one of (1) to (3), wherein

identification information is assigned to the metadata received by the metadata reception portion, the identification information identifying a device model when the content data is different for each device model, even with same content.

(5) The information processing device according to (4), wherein

the content data storage portion determines the directory structure without taking the identification information into consideration when storing the content data.

(6) The information processing device according to any one of (1) to (5), wherein

when a content version is upgraded, the content data storage portion changes the directory structure when storing the content data, in accordance with how the content version is upgraded.

(7) An information processing method including:

receiving metadata that is attached to content data and transmitted;

analyzing the metadata received in the metadata receiving step; and

determining a storage method of the content data based on a result of the analysis in the metadata analyzing step,

wherein

based on the analysis by the metadata analyzing step, the content data storing step changes a directory structure when storing the content data, in accordance with a content of a predetermined element of the metadata received in the metadata receiving step.

(8) A computer program including instructions that command a computer to perform:

receiving metadata that is attached to content data and transmitted;

analyzing the metadata received in the metadata receiving step; and

determining a storage method of the content data based on a result of the analysis in the metadata analyzing step,

wherein

based on the analysis by the metadata analyzing step, the content data storing step changes a directory structure when storing the content data, in accordance with a content of a predetermined element of the metadata received in the metadata receiving step.

The present disclosure contains subject matter related to that disclosed in Japanese Priority Patent Application JP 2011-224640 filed in the Japan Patent Office on Oct. 12, 2011, the entire content of which is hereby incorporated by reference.

What is claimed is:

1. An information processing device comprising:
a metadata reception portion that receives metadata that is attached to content data and transmitted;
a metadata analysis portion that analyzes the metadata received by the metadata reception portion; and
a content data storage portion that determines a storage method of the content data based on a result of the analysis by the metadata analysis portion;
wherein
based on the analysis by the metadata analysis portion, the content data storage portion changes a directory structure when storing the content data, in accordance with a content of a predetermined element of the metadata received by the metadata reception portion.

2. The information processing device according to claim 1, wherein
based on the analysis by the metadata analysis portion, the content data storage portion changes the directory structure when storing the content data, in accordance with whether a predetermined element of the metadata is limited to being used in the information processing device itself.

3. The information processing device according to claim 1, wherein
based on the analysis by the metadata analysis portion, the content data storage portion changes the directory structure when storing the content data, in accordance with whether a predetermined element of the metadata is used in common between elements of a higher hierarchy than the predetermined element.

4. The information processing device according to claim 1, wherein
identification information is assigned to the metadata received by the metadata reception portion, the identification information identifying a device model when the content data is different for each device model, even with same content.

5. The information processing device according to claim 4, wherein
the content data storage portion determines the directory structure without taking the identification information into consideration when storing the content data.

6. The information processing device according to claim 1, wherein
when a content version is upgraded, the content data storage portion changes the directory structure when storing the content data, in accordance with how the content version is upgraded.

7. An information processing method comprising:
receiving metadata that is attached to content data and transmitted;
analyzing the metadata received in the metadata receiving step; and
determining a storage method of the content data based on a result of the analysis in the metadata analyzing step,
wherein
based on the analysis by the metadata analyzing step, the content data storing step changes a directory structure when storing the content data, in accordance with a content of a predetermined element of the metadata received in the metadata receiving step.

8. A computer program comprising instructions that command a computer to perform:
receiving metadata that is attached to content data and transmitted;
analyzing the metadata received in the metadata receiving step; and
determining a storage method of the content data based on a result of the analysis in the metadata analyzing step,
wherein
based on the analysis by the metadata analyzing step, the content data storing step changes a directory structure when storing the content data, in accordance with a content of a predetermined element of the metadata received in the metadata receiving step.
